(19) United States
(12) Patent Application Publication
(10) Pub. No.: US 2023/0292232 A1
(43) Pub. Date: Sep. 14, 2023

(54) METHOD AND APPARATUS FOR FALLBACK HANDLING

(71) Applicant: ZEKU, INC., Palo Alto, CA (US)

(72) Inventors: Su-Lin LOW, San Diego, CA (US); Hong Kui YANG, San Diego, CA (US)

(21) Appl. No.: 18/317,556

(22) Filed: May 15, 2023

Related U.S. Application Data
(63) Continuation of application No. PCT/US2020/061403, filed on Nov. 20, 2020.

(51) Int. Cl. H04W 48/18

(52) U.S. Cl. CPC H04W 48/18

(57) ABSTRACT

A method for fallback handling is provided. The method for fallback handling includes operating a user equipment in a fifth-generation (5G) radio access technology. The method also includes maintaining second-generation (2G) and third-generation (3G) physical layer components in a warm state. The method further includes maintaining 2G and 3G layer 2 components in an inactive state.

### CROSS-REFERENCE TO RELATED APPLICATIONS

This application is a continuation of International Application No. PCT/US2020/061403, filed Nov. 20, 2020, the entire disclosure of which is incorporated herein by reference.

### BACKGROUND

Embodiments of the present disclosure relate to apparatuses and methods for wireless communication.

Wireless communication systems are widely deployed to provide various telecommunication services such as telephony, video, data, messaging, and broadcasts. In cellular communication, such as the 4th-generation (4G) Long Term Evolution (LTE) and the 5th-generation (5G) New Radio (NR), the 3rd Generation Partnership Project (3GPP) defines a protocol stack that includes a set of layers collectively referred to as layer 2: a Packet Data Convergence Protocol (PDCP) layer, a Radio Link Control (RLC) layer, and a Medium Access Control (MAC), from higher to lower in the stack. These lie above the physical layer (PHY) in the stack. PHY is also referred to as layer 1. These layer 2 and layer 1 circuits may be present in multiple versions in a given user equipment, if the user equipment is capable of operating in various radio access technologies.

### SUMMARY

In a first aspect, a method for fallback handling is provided. The method includes operating a user equipment in a fifth-generation (5G) radio access technology. The method also includes maintaining second-generation (2G) and third-generation (3G) physical layer components in a warm state. The method further includes maintaining 2G and 3G layer 2 components in an inactive state.

In a second aspect, an apparatus for fallback handling is provided. The apparatus includes at least one processor and at least one memory including computer program code. The at least one memory and the computer program code are configured to, with the at least one processor, cause the apparatus to perform: operating a user equipment in a fifth-generation (5G) radio access technology; and transitioning to a second-generation (2G) or third-generation (3G) radio access technology only when out of service (OOS) coverage or internet protocol (IP) multimedia subsystem (IMS) failure occur.

In a third aspect, a method for fallback handling is provided. The method includes operating a user equipment in a fifth-generation (5G) radio access technology. The method also includes at least one of: determining a likelihood of fallback to at least one of a second-generation (2G) or third-generation (3G) radio access technology, and falling back to the 2G or 3G radio access technology only when the likelihood exceeds a threshold; or falling back to at least one of a 2G, 3G, or fourth-generation (4G) radio access technology, and when attempting to return to the 5G radio access technology from the 2G, 3G, or 4G radio access technology, performing only idle mode search of the 5G radio access technology system.

In a fourth aspect, an apparatus for fallback handling is provided. The apparatus includes at least one processor and at least one memory including computer program code. The at least one memory and the computer program code are configured to, with the at least one processor, cause the apparatus to perform the method of the first aspect.

### BRIEF DESCRIPTION OF THE DRAWINGS

The accompanying drawings, which are incorporated herein and form a part of the specification, illustrate embodiments of the present disclosure and, together with the description, further serve to explain the principles of the present disclosure and to enable a person skilled in the pertinent art to make and use the present disclosure.

FIG. 1 illustrates a coverage map involving a mixture of coverage types, consistent with certain embodiments of the present disclosure.

FIG. 2 illustrates UE modem stacks, consistent with certain embodiments of the present disclosure.

FIG. 3 illustrates a state diagram of an overview of certain embodiments of the present disclosure.

FIG. 4 illustrates a first alternative, namely 5G/4G minimized fallback and resume, for a non-standalone user equipment, according to certain embodiments of the present disclosure.

FIG. 5 illustrates a second alternative, namely 5G/4G fast optimized fallback and resume, for a non-standalone user equipment, according to certain embodiments of the present disclosure.

FIG. 6 illustrates UE modem stacks, consistent with certain embodiments of the present disclosure.

FIG. 7 illustrates a state diagram of an overview of certain embodiments of the present disclosure.

FIG. 8 illustrates 5G minimized fallback and resume for a user equipment in 5G standalone, according to certain embodiments.

FIG. 9 illustrates 5G fast optimized fallback and resume for a user equipment in 5G standalone, according to certain embodiments.

FIG. 10 illustrates a node in accordance with certain embodiments.

FIG. 11 illustrates a network including a plurality of nodes, in accordance with certain embodiments.

Embodiments of the present disclosure will be described with reference to the accompanying drawings.

### DETAILED DESCRIPTION

Although specific configurations and arrangements are described, it should be understood that this is done for illustrative purposes only. A person skilled in the pertinent art will recognize that other configurations and arrangements can be used without departing from the spirit and scope of the present disclosure. It will be apparent to a person skilled in the pertinent art that the present disclosure can also be employed in a variety of other applications.

It is noted that references in the specification to “one embodiment,” “an embodiment,” “an example embodiment,” “some embodiments,” “certain embodiments,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure, or characteristic is described in connection with an embodiment, it would be within the knowledge of a person skilled in the pertinent art to effect such feature, structure, or characteristic in connection with other embodiments whether or not explicitly described.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Various aspects of wireless communication systems will now be described with reference to various apparatus and methods. These apparatus and methods will be described in the following detailed description and illustrated in the accompanying drawings by various blocks, modules, units, components, circuits, steps, operations, processes, algorithms, etc. (collectively referred to as “elements”). These elements may be implemented using electronic hardware, firmware, computer software, or any combination thereof. Whether such elements are implemented as hardware, firmware, or software depends upon the particular application and design constraints imposed on the overall system.

The techniques described herein may be used for various wireless communication networks, such as code division multiple access (CDMA) system, time division multiple access (TDMA) system, frequency division multiple access (FDMA) system, orthogonal frequency division multiple access (OFDMA) system, single-carrier frequency division multiple access (SC-FDMA) system, and other networks. The terms “network” and “system” are often used interchangeably. A CDMA network may implement a radio access technology (RAT), such as Universal Terrestrial Radio Access (UTRA), evolved UTRA (E-UTRA), CDMA 2000, etc. A TDMA network may implement a RAT, such as the Global System for Mobile Communications (GSM). An OFDMA network may implement a RAT, such as LTE or NR. The techniques described herein may be used for the wireless networks and RATs mentioned above, as well as other wireless networks and RATs.

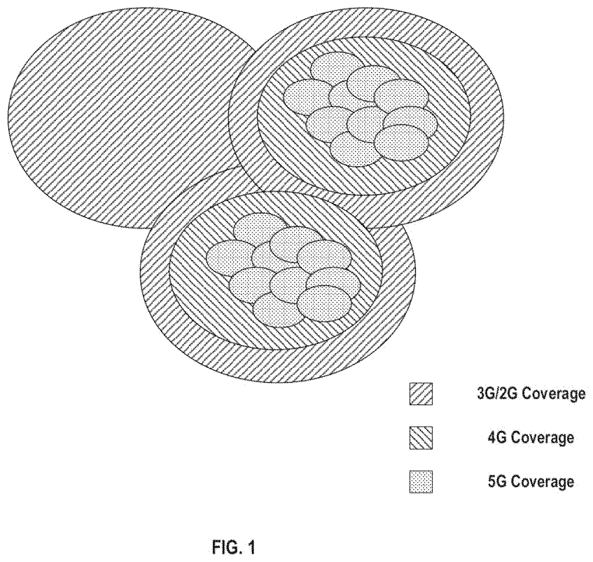

FIG. 1 illustrates a coverage map involving a mixture of coverage types, consistent with certain embodiments of the present disclosure.

In a typical fifth-generation (5G) cellular deployment as illustrated in FIG. 1, a typical carrier may employ 5G systems in small centralized hot coverage zones where 5G specific low latency and high throughput applications are expected. Such coverage areas may be overlaid with legacy long term evolution (LTE) fourth-generation (4G) systems where the coverage area is broader. In addition, these areas are typically overlaid with legacy third-generation (3G)/second-generation (2G) systems to provide ubiquitous coverage and to allow fallback in case any user equipment (UE) moves out of coverage from the 5G or 4G systems.

A UE that can operate in multiple radio access technologies (RATs) (for example, 5G, 4G, 3G, and 2G) may use a multi-RAT system selection search for a suitable and validated system to acquire. Once it acquires a 5G system and when it is in idle mode, it will perform periodic measurements for neighboring cells to evaluate if it needs to do a reselection to the same or different RAT on another cell, which has better coverage.

If a reselection to a lower technology RAT (for example, 3G) has occurred, the UE may also perform periodic measurement on neighbor cells to see if the UE can trigger a reselection to a higher technology RAT (for example, 5G) as soon as possible.

At boundaries between 5G and legacy system coverage, a ping-pong from 5G/4G to legacy RATs and back to 5G/4G systems may occur.

To address mixed coverage, a 5G/4G non-stand-alone (NSA) UE may typically possess legacy 3G, 2G protocol, L2 and L1 stacks that are not kept in an inactive state. Instead, these radio systems may be prepared to make periodic measurements on the neighboring 3G and 2G base stations. When the UE moves out of coverage of the 5G/4G networks, and when the 3G or 2G signal strengths exceeds a threshold above the current 5G/4G systems, the UE can reselect to the legacy 3G or 2G networks.

A 5G-centric UE may be configured to stay in the 5G/4G system as much as possible and to be able to fall back to legacy 3G/2G systems only if absolutely necessary, with the minimum amount of complexity and power.

Such an approach may require complex logic to keep all multi-RATs stack—5G, 4G, 3G, and 2G—to be non-inactive state to facilitate Inter-RAT reselections among the RATs. Additionally, such an approach may require complicated and multiple subscriber identity module (SIM) logic to facilitate interworking among 5G, 4G, 3G, and 2G.

Additionally, such an approach may perform excessive measurements causing inefficient resource usage at the physical (PHY) layer. The excessive measurement can also require increased power in the UE and can cause interference in the network.

In such an approach, there may also be complicated arbitration of radio frequency (RF) resources sharing among Multiple RATs. There may be a need for significant software logic and code space for multi-RAT protocol stack control. Additionally, the complicated issues may lead to non-optimal fallback to legacy systems instead of staying in 5G as long as possible

In certain embodiments of the present disclosure, a set of simple and minimal 5G Centric User Equipment (UE) Fallback and Resume schemes from 5G/4G to legacy 3GPP protocol stacks including 3G and 2G are illustrated. Certain embodiments of the method may use less power and may eliminate complex multi-RAT arbitration logic by triggering a fallback from 5G/4G to legacy systems only when absolutely necessary.

A set of simplified and minimal 5G Centric User Equipment (UE) fallback and resume schemes from 5G/4G Non-Standalone (NSA) or 5G Standalone (SA) to legacy 3GPP 3G/2G protocol stacks is also explained.

At least five different aspects of certain embodiments can be provided below in detail. A first aspect of certain embodiments relates to maintaining legacy protocol stacks of a user equipment in a cold state when the user equipment is in 5G/4G only mode, non-stand-alone. In this aspect, which is described at greater length below, a 5G-centric UE can power up into a “5G4G_Only” NSA Mode if it acquires a 5G or 4G network for maximum performance for data throughput and latency. The legacy 3G, 2G protocol stacks can all be inactive, in a “COLD” state. The PHY layers for 2G and 3G may be powered up and put into a low power “WARM” state.

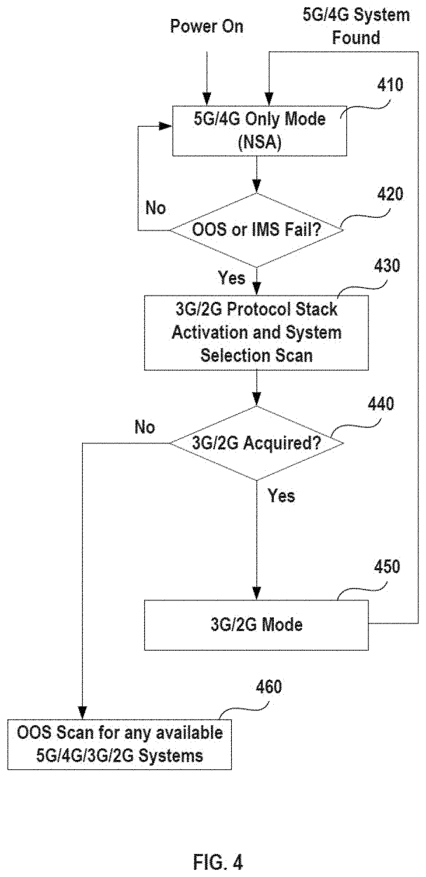

A second aspect of certain embodiments relates to a first fallback scheme for a user equipment in 5G/4G only mode, which can also be described as non-stand-alone mode. This aspect is illustrated in FIG. 4 and described below. In this aspect, which is described at greater length below, a 5G-centric NSA UE can transition to legacy systems with a simplified and minimized path, only upon out-of-service (OOS) coverage or internet protocol (IP) multimedia subsystem (IMS) failures. The legacy 3G/2G PHY layers may be brought up in warm start, and the 3G/2G protocol stacks may be activated from cold start.

A third aspect of certain embodiments relates to a second fallback scheme for a user equipment in 5G/4G only mode. In this aspect, which is described at greater length below, an alternate path to fallback to legacy systems is provided, using a scoring function to evaluate the likelihood of fallback occurrence paths, taking into account, for example, the location of neighboring legacy base stations and current UE receive signals.

A fourth aspect of certain embodiments relates to resuming 5G/4G without performing connected state handovers. In this aspect, which is described at greater length below, to resume to 5G/4G, this method can include doing only idle search by measuring and acquiring higher 5G/4G systems, without performing connected state handovers.

A fifth aspect of certain embodiments relates to 5G only, standalone user equipment. This can be viewed as an extension of the above aspects to UEs that are 5G only standalone (SA), or 5G and beyond only.

As mentioned above, FIG. 1 illustrates a coverage map involving a mixture of coverage types, consistent with certain embodiments of the present disclosure. More particularly, FIG. 1 illustrates an example of 5G deployment with 3GPP legacy LTE, 4G, 3G, and 2G coverage.

One goal for a 5G centric UE may be to stay in the 5G/4G system as much as possible and to be able to fall back to legacy 3G/2G systems only if absolutely necessary, with the minimum amount of complexity and power. Certain embodiments of the present disclosure may provide these and other benefits and advantages.

As mentioned above, certain embodiments may provide a set of simplified and minimal 5G-centric UE fallback and resume schemes from 5G/4G NSA or 5G SA to legacy 3GPP 3G/2G protocol stacks.

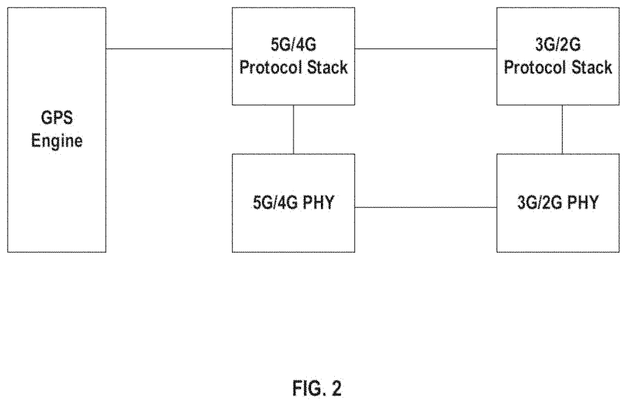

FIG. 2 illustrates UE modem stacks, consistent with certain embodiments of the present disclosure. The 5G/4G protocol stack and PHY layer are active most of the time in this 5G centric modem, and the goal is to remain in 5G/4G only mode (NSA) as much as possible. In this mode, the 5G and 4G systems are interworking per 3GPP IRAT protocols.

In addition, the global positioning system (GPS) engine, which provides accurate location data for the UE, allows the UE to calculate the distance to the nearest neighboring legacy base stations. The location information for the legacy base stations can be broadcast to the UEs in 5G/4G overhead messages. The GPS engine may be kept in an active mode. It is understood that the GPS engine may broadly encompass any suitable positioning engines, such as Galileo, global navigation satellite system (GLONASS), BeiDou navigation system, etc.

The legacy 3G/2G protocol stacks are in cold or inactive mode. The corresponding 3G/2G PHY layers are powered up but put into a low power mode or a warm state. The protocol stacks and physical layers may be considered to be low power mode when they are receiving current, but a lower level of current than during typical active operation, either because some components are inactive, or the like.

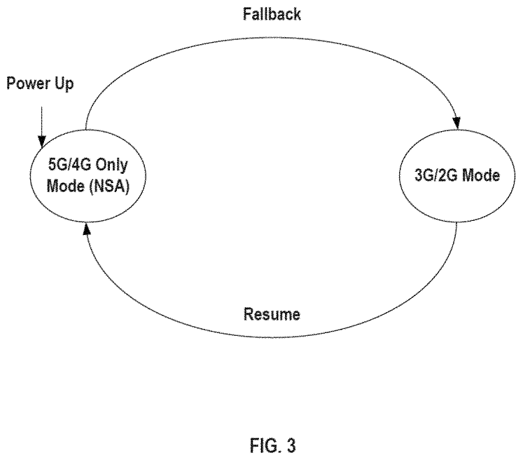

FIG. 3 illustrates a state diagram of an overview of certain embodiments of the present disclosure. When the UE powers up, it can attempt to acquire a 5G or 4G system. Once successful, the UE can enter the 5G/4G Only Mode (NSA), where only the 5G or 4G Protocol Stack and PHY layers are active. The legacy 3G/2G protocol stacks can be in an inactive or cold state, and their respective PHY layers can be powered up but in a low power or warm state.

At the 5G/4G and 3G/2G cell edges, the UE may have to fall back to these legacy RATs. To do this effectively, either a first alternative, 5G/4G minimized fallback and resume, or a second alternative, 5G/4G fast optimized fallback and resume, can be chosen.

In the first alternative, in the event that the UE goes out of coverage of 5G/4G, or if IMS failures occur, the UE can transition to the 3G/2G mode. In these legacy modes, the UE can periodically scan for 5G and 4G systems to resume during idle search. The idle search can include periodic measurements as a result of the periodic scanning of higher systems. No connected handovers may be done.

In the second alternative, the UE can use a scoring function instead to evaluate the likelihood of fallback occurrence paths before actually performing the reselection to the legacy RATs. This scoring function can take into account the location of neighboring legacy base stations and current signals received by the UE. Similar to the first alternative, a simplified approach can be taken to resume to 5G/4G as soon as possible by performing idle search. No connected handovers may be done.

FIG. 4 illustrates a first alternative, namely 5G/4G minimized fallback and resume, for a non-standalone user equipment, according to certain embodiments of the present disclosure.

As shown in FIG. 4, at 410 the UE may be in 5G/4G only non-standalone mode after powering on and acquiring a 4G or 5G system. In this mode, the UE can perform 5G/4G interworking per 3GPP inter-RAT (IRAT) protocols. The legacy 3G/2G protocol stacks can be in cold state, and their PHY layers can be powered up but put into a lower power warm state.

The user equipment may, at 420, periodically check whether one of a limited number of fallback conditions is met. Alternatively, the occurrence of one of the limited number of fallback conditions may trigger the UE to act. The limited number of conditions may be, for example, that there is an out-of-service condition or an IMS failure, such as an IMS registration failure or an IMS call setup failure.

At 430, assuming the fallback condition is met, the UE can activate the 3G/2G protocol stack and perform a system selection scan for 3G/2G systems closest to the UE. In activating, the UE can activate the 3G/2G protocol stacks with cold start, and the PHY layers can be activated with warm start.

At 440, the UE can determine whether a valid 3G/2G has been acquired. If so, then at 450, the UE can operate in 3G/2G mode until a 5G/4G system is found and the process returns to 410. Otherwise, the user equipment can perform an OOS scan for any available system of any time, for example, 5G, 4G, 3G, or 2G, at 460.

While trying to acquire a 3G/2G RAT, the user equipment can use a legacy 3G/2G system selection algorithm is activated. The UE can scan for selected 3G or 2G base stations closest to the UE, using neighbor system's information from the previous 5G/4G broadcasted overhead signaling message and location information obtained from GPS data. Once a 3G or 2G system is acquired, the system can be validated so that the UE can transition to the 3G/2G mode.

After entering 3G/2G mode at 450, the user equipment can periodically search for neighboring strong 5G/4G systems and can perform measurements during idle search, so that the user equipment can reselect back to the higher systems of 5G/4G as soon as possible. No connected mode handovers are needed and can consequently be avoided in this approach.

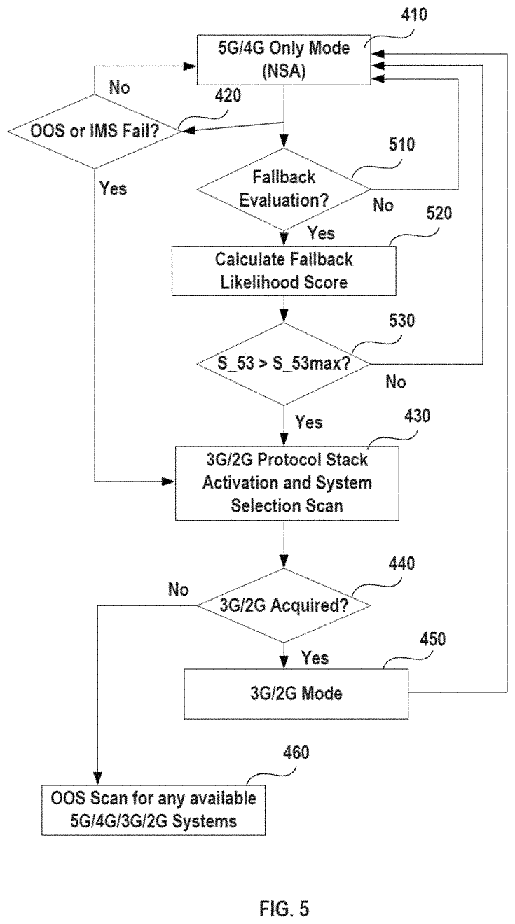

FIG. 5 illustrates a second alternative, namely 5G/4G fast optimized fallback and resume, for a non-standalone user equipment, according to certain embodiments of the present disclosure. This approach includes many of the same features shown in FIG. 4, but additionally includes a fast fallback path.

As in FIG. 4, the user equipment can, at 420, determine whether there is an IMS failure or an OOS condition. If so, the process can proceed as described in FIG. 4, at 430, by activating the 3G/2G protocol stack.

On the other hand, in FIG. 5, there is an additional path. The additional path begins 510 with determining whether to conduct a fallback evaluation. In this path, as will be discussed at greater length below, the UE evaluates fallback likelihood and performs the reselection only if the likelihood of fallback is significantly high enough to justify the transition.

After powering up and acquiring a 5G/4G system and entering the 5G/4G only mode at 410 as in the approach of FIG. 4, the UE can measure its 5G or 4G receive power, P5. If this power is less than a specified threshold, P5 min, for a specified time interval, T5min, then at 510, the 5G/4G protocol stack can be triggered to perform an evaluation of a fallback possibility.

At 520, the user equipment can calculate a fallback likelihood score. In other words, when fallback evaluation is triggered by received power falling below a threshold value for too long, the UE can check whether the UE may need to fall back to a 3G/2G system, for example, in case the UE is at the cell edge of 5G coverage and legacy system coverage. The UE can evaluate its likelihood of fallback by, at 520, calculating a fallback likelihood score.

The fallback likelihood score for 5G/4G to 3G/2G, S_53, can be calculated as follows:

$$S\_ 53 = \frac{[ k 2 ( I 5 ) * k 4 ( B 5 ) ]}{[ k 1 ( P 5 ) * k 3 ( {D}_{532} ) * k 5 ( L 5 ) ]} ,$$

where P5 is the receive signal strength of the 5G/4G system, as mentioned above, I5 is received interference of the 5G/4G system, D₅₃₂ is the distance from the UE to the nearest 3G or 2G base station, B5 is the average data buffer queue size at UE, and L5 is the smallest latency value of the packet data application at the UE.

The remaining factors, k1, k2, k3, k4, and k5 may be tunable factors for the scoring functions for each variable input. Note that D₅₃₂ (distance from the UE to the nearest 3G or 2G base station) can be derived with GPS data for the UE, and the location data from 3GPP overhead information about the legacy RATs base stations' coordinates.

At 530, the user equipment whether S_53 is greater than a threshold value, S_53 min. If so, then the likelihood is considered to be relatively high that fallback will be needed. Accordingly, the user equipment can proceed as described above at 430. Otherwise, the user equipment can return to 410.

When the likelihood is above a threshold, a fallback from the 5G/4G to 3G/2G system can be triggered before the UE goes out-of-service on the 5G/4G system.

By ensuring that the UE is highly likely to need to perform a fallback, this scheme can avoid some ping-pongs to and from the lower systems from occurring unnecessarily.

The above aspects have focused on the non-standalone mode user equipment scenarios. Certain embodiments may also or alternatively be applied to a 5G centric UE configured to operate in a state that is 5G Only (SA Mode). A scheme to fallback and resume to/from the legacy 4G, 3G, and 2G systems can be extended from the above methods, as described in the following non-limiting examples.

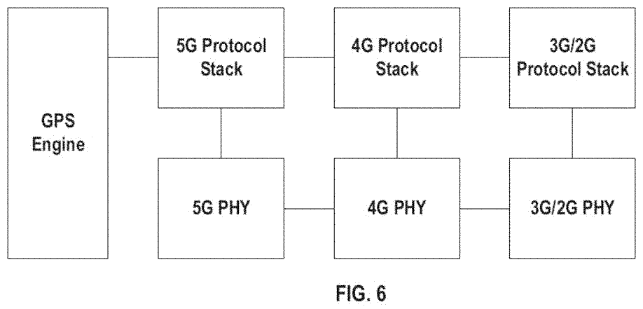

FIG. 6 illustrates UE modem stacks, consistent with certain embodiments of the present disclosure. FIG. 6 more particularly illustrates the modem stack as it may be in an SA mode. The 5G protocol stack and PHY layer may be active most of the time in this 5G centric modem, and a goal may be to remain in 5G mode as much as possible. The 4G protocol stack, as well as the 3G/2G protocol stacks, may all be in cold or inactive mode. The corresponding 4G and 3G/2G PHY layers are powered up but put into a low power mode or a warm state.

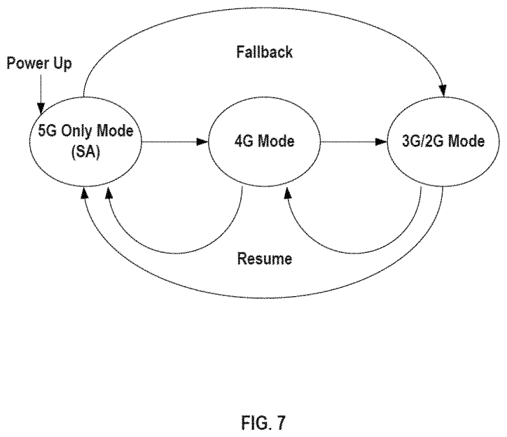

FIG. 7 illustrates a state diagram of an overview of certain embodiments of the present disclosure. More particularly, FIG. 7 provides an overview of some additional schemes of the present disclosure, which can be viewed as extensions from the previously illustrated schemes.

As shown in FIG. 7, when a UE powers up, the US can attempt to acquire a 5G system. Once successful, the UE can enter 5G Only Mode, where only the 5G protocol stack and PHY layers are active. The legacy 4G/3G/2G Protocol Stacks can be in an inactive or cold state, and their respective PHY layers can be powered up but in a low power or warm state.

At the 5G and 4G/3G/2G cell edges, the UE may have to fall back to these legacy RATs. To do this effectively, either the above-described minimized fallback and resume path, or the 5G fast optimized fallback and resume, can be chosen by design.

According to the first alternative, in the event that the UE goes out of coverage, or if IMS failures occur, the UE can transition to 4G Mode or directly 3G/2G mode, depending on which system is located in a search. The user equipment may preferentially select 4G radio access technology over 3G/2G radio access technologies. In these legacy modes, the UE periodically scans for 5G systems to resume during idle search. No connected mode handovers are performed in some embodiments.

According to the second alternative, the UE can use a scoring function instead of only relying on OOS and IMS failure to evaluate the likelihood of fallback occurrence paths before actually performing the reselection to the legacy RATs. This scoring function can take into account the location of neighboring legacy base stations and currently received signals at the UE. Once fallback occurs, the UE can resume using idle search procedures to return to the 5G system as soon as possible. As shown in FIG. 7, from 2G/3G mode, the UE may first return to a 4G mode based on coverage availability.

In 3G/2G, the idle search may involve periodic scanning and measurements of higher systems, including both 4G and 5G. Similarly, in 4G mode, the idle search may involve periodic scanning and measurements of higher systems, namely 5G systems. Although these examples treat 5G as the highest level of the system (because it is currently the highest level in widespread use), these same principles may also be applied to any subsequent radio access technologies in a similar way.

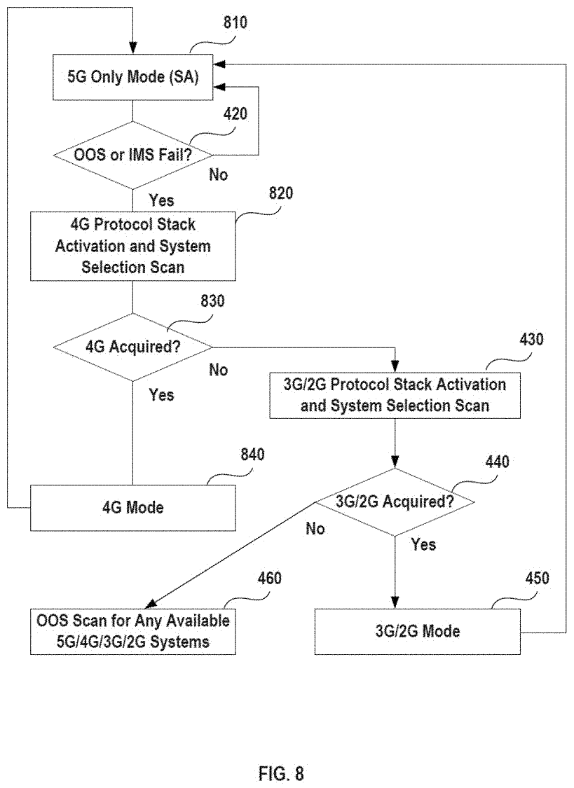

FIG. 8 illustrates 5G minimized fallback and resume for a user equipment in 5G standalone, according to certain embodiments. A 5G-centric UE may power up in 5G only mode, also known as standalone mode, at 810 after acquiring a 5G system. The legacy 4G/3G/2G protocol stacks may be in cold state, and their PHY layers may be powered up but put into a lower power warm state. Upon out-of-service coverage, IMS registration failure, or IMS call setup failure detection at 420, the UE may activate the 4G LTE protocol stack at 820. The UE may activate the 4G protocol stacks with cold start, and the PHY layers may be activated with warm start. Meanwhile, at this point the 3G/2G protocol stacks may be maintained in cold state, and their PHY layers may continue to be powered up but kept in a lower power warm state.

A 4G LTE system selection mechanism can be activated and can scan for selectable 4G base stations closest to the UE. The neighboring system's information can be broadcasted in the 5G overhead signaling message. At the UE, the location of the closest 4G base stations can also be obtained.

Once a 4G system is acquired at 830, the 4G system can be validated so that the UE can transition to 4G Mode at 840. In this mode, the UE can periodically search for neighboring strong 5G systems and perform measurements during idle search, so that the user equipment can reselect back to the higher systems and return to 810 as soon as possible. All connected mode handovers may be avoided.

If at 830 no 4G systems can be acquired, or if no 4G systems can be validated after being acquired, the 3G/2G protocol stack can be activated at 430, as in the previous examples. The user example can activate the 3G/2G Protocol stacks with cold start, and the PHY layers can be activated with a warm start. The UE can scan for particular 3G or 2G base stations closest to the UE, using neighbor system's information from a previous 5G overhead signaling message and location information obtained from GPS data. Once a 3G or 2G system is acquired at 440, the acquired system can be validated so that the UE can transition to the 3G/2G mode at 450.

In 3G/2G mode, as in previous examples, the UE can periodically search for neighboring strong 5G/4G systems and can perform measurements during idle search, so that the user equipment can reselect back to the higher systems of 5G/4G as soon as possible. No connected mode handovers may be performed.

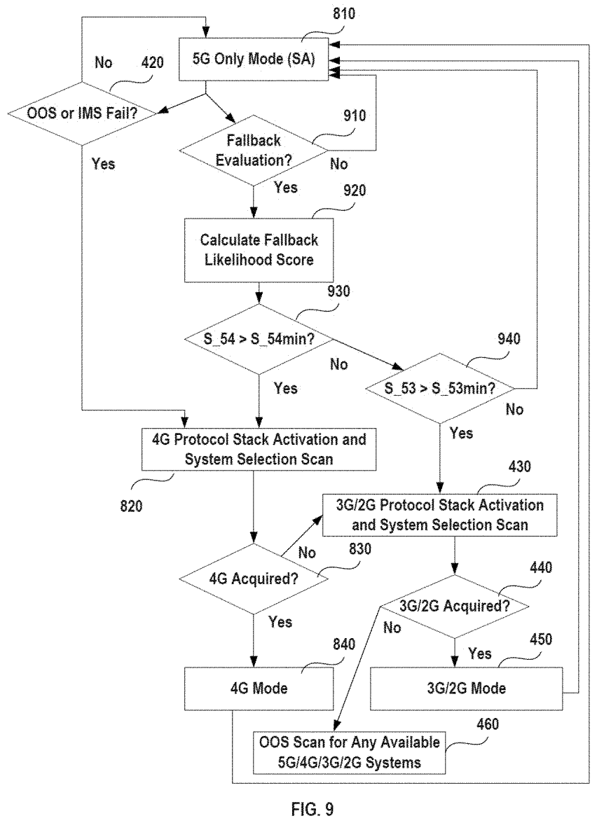

FIG. 9 illustrates 5G fast optimized fallback and resume for a user equipment in 5G standalone, according to certain embodiments. FIG. 9 is to FIG. 8 as FIG. 5 is to FIG. 4, in that it adds a fast fallback option based on performing an evaluation.

As shown in FIG. 9, an alternate path is provided for 5G fast optimized fallback, where the UE can perform the reselection only if the likelihood of fallback (also referred to as hand-down) is significantly high enough to justify the transition.

After powering up and acquiring a 5G system and entering the 5G only mode at 810, the UE can measure its 5G receive power, P5. If this power is less than a specified threshold P5 min for a specified T5 min time interval, then at 910, the 5G protocol stack can be triggered to perform an evaluation of a fallback possibility.

The UE can evaluate its likelihood fallback, also referred to as hand-down, by calculating a fallback likelihood score at 920. This calculation can be similar to the calculation described above. However, there can be a separate calculation for fallback to 4G as opposed to fallback to 3G/2G.

At 930, the user equipment can perform fallback likelihood scoring for 5G to 4G. The UE can evaluate its likelihood of fallback by calculating a 5G to 4G fallback likelihood score, S_54 as follows:

$$S\_ 54 = \frac{[ k 7 ( I 5 ) * k 9 ( B 5 ) ]}{[ k 6 ( P 5 ) * k 8 ( {D}_{54} ) * k 10 ( L 5 ) ]} ,$$

where P5 is the receive signal strength of the 5G system at the user equipment, I5 is the received interference to the 5G system, D₅₄ is the distance from the UE to the nearest candidate 4G base station, B5 is the average data buffer queue size at the user equipment, and L5 is the smallest latency value of the packet data application at the user equipment.

The remaining factors, k6, k7, k8, k9, and k10 may be tunable factors for the scoring functions for each variable input. Note that D₅₄, the distance from the UE to the nearest 4G base station, can be derived with GPS data for the UE, and the location data from the 3GPP overhead information about the legacy RATs base stations' coordinates.

If S_54>S_54 min, then the likelihood of a fallback from the 5G to a nearby 4G system is justifiable, and a fallback from the 5G to 4G system can be triggered before the UE goes out of service on the 5G system. By ensuring that the UE most likely need to perform a fallback, this scheme avoids fallback to the lower systems from occurring unnecessarily.

At 820, as also described above, once fallback is triggered, the 4G protocol stack can be activated immediately, and 4G system selection can be triggered to scan for a valid 4G system, starting with the closest 4G base station. The user equipment can activate the 4G Protocol stacks with cold start, and the PHY layers can be activated with warm start.

If a 5G packet data session is ongoing when fallback occurs, the packet data session can be forced into a dormant mode where the IP data stack layers context is kept until the new 4G RAT is acquired.

If, at 830, it is determined that 4G is acquired and validated, then at 840, the user equipment can transition into 4G mode. In this mode, the UE periodically scans for a higher or better system (5G) during Idle Search. Once any 5G system is found, the UE can resume to the higher system. No connected mode handovers are performed in certain embodiments.

If the scoring Function S_54 criteria for 5G to 4G is not met, or if no 4G acquired systems are validated, then the UE can check whether the UE should try to fall back to a 3G/2G system, in case the UE is at the cell edge of such legacy systems.

The fallback likelihood score for 5G to 3G/2G, S_53, can be calculated as already explained above. If, at 940, S_53 is greater than a threshold value, S_53 min, then the likelihood of a fallback from 5G to a nearby 3G/2G system may be deemed justifiable, and a fallback from the 5G to 3G/2G system may be triggered before the UE goes out-of-service on the 5G system. By ensuring that the UE most likely need to perform a fallback, this scheme avoids unnecessary transfers to the lower systems.

Once the condition is met, at 430, the 3G/2G protocol stack can be activated immediately, and the 3G/2G System Selection algorithm can be triggered to scan for a valid 3G/2G system, starting with the closest legacy base station.

Meanwhile, the UE can periodically search for neighboring strong 5G/4G systems and perform measurements during idle search, so that the UE can reselect back to the higher systems of 5G/4G as soon as possible, without the need for connected mode handovers.

Certain embodiments provide various benefits and/or advantages. For example, certain embodiments can eliminate complex multi-RAT arbitration logic by triggering a fallback from 5G/4G to legacy 3G/2G systems via two methods referred to respectively as 5G/4G minimized fallback and resume and 5G/4G fast optimized fallback & resume. Thus, certain embodiments may allow a 5G-centric UE to stay in the 5G/4G (NSA) system as much as possible and to be able to fall back to legacy 3G/2G systems only if absolutely necessary, with the minimum amount of complexity and power. In addition, certain embodiments also apply to 5G only fallback to legacy 4G, and 3G/2G systems, for UEs which are configured to prefer to be in 5G only (SA). Similarly, the 5G minimized fallback and resume and 5G fast optimized fallback and resume provide mechanisms to enable such benefits and/or advantages.

Accordingly, more broadly some embodiments provide a practical scheme with minimal software complexity. Moreover, certain embodiments eliminate complex multi-RAT arbitration logic and code space among multiple RATs protocol stacks of 5G, 4G, 3G, and 2G. Furthermore, certain embodiments eliminate complicated multiple SIM logic to facilitate interworking among 5G, 4G, 3G, and 2G. Moreover, certain embodiments eliminate complicated arbitration of RF resources sharing among multiple RATs.

Also, certain embodiments eliminate multiple legacy 3G/2G RATs being in non-inactive state for Inter-RAT reselections. Additionally, certain embodiments eliminate inefficient resource usage at the PHY layer for excessive measurements. Certain embodiments prevent a 5G-centric UE from ping-pong to the lower legacy 3G/2G systems unnecessarily. Moreover, certain embodiments allow a 5G-centric UE to stay in 5G/4G systems as long as possible with enhanced performance.

Certain embodiments also avoid complicated resume logic from legacy systems to 5G/4G systems. Furthermore, certain embodiments provide for decreased power usage in the 5G centric UE. Additionally, certain embodiments may result in reduced interference in the network.

Other variations to the above embodiments are also possible. For example, the triggering of the fallback evaluation may be based on additional or different criteria, such as taking into account the location of legacy base stations in the vicinity. Additionally, certain embodiments may implement a ping-pong condition check to ensure that the UE performs the fallback at an appropriate frequency.

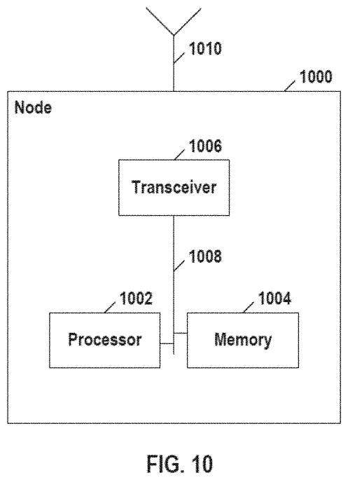

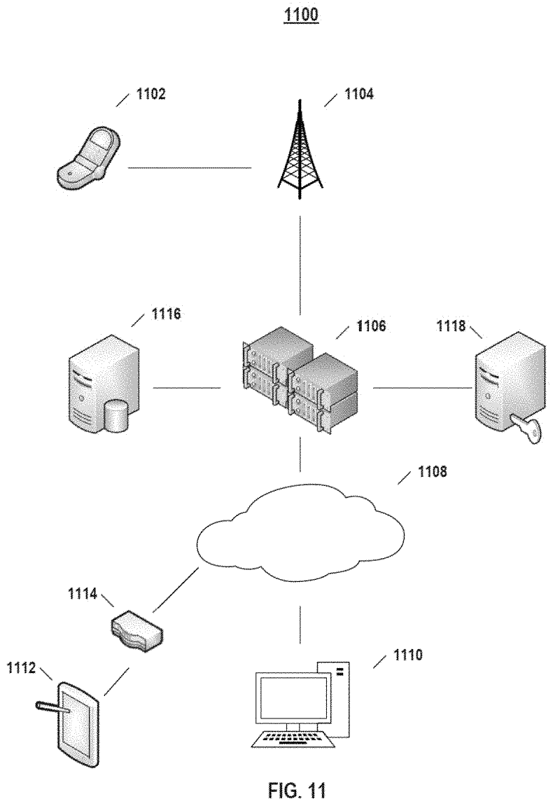

The above methods may be applicable to a variety of different devices, with user equipment being an example. More generally, the method may be used in a node of a wireless network. FIG. 10 illustrates a node in accordance with certain embodiments. FIG. 11 illustrates a network including a plurality of nodes, in accordance with certain embodiments.

As shown in FIG. 10, a node 1000 may include a processor 1002, a memory 1004, a transceiver 1006. These components are shown as connected to one another by bus 1008, but other connection types are also permitted. When node 1000 is user equipment 1102 in FIG. 11, additional components may also be included, such as a user interface (UI), sensors, and the like. Similarly, node 1000 may be implemented as a blade in a server system when node 1000 is configured as core network element 1106 in FIG. 11. Other implementations are also possible.

Transceiver 1006 may include any suitable device for sending and/or receiving data. For example, transceiver 1006 may implement the protocol stacks also known as the layer 2 circuits and physical layer also known as layer 1 circuits, described above, for example, with reference to FIGS. 2 and 6. Node 1000 may include one or more transceivers, although only one transceiver 1006 is shown for simplicity of illustration. An antenna 1010 is shown as a possible communication mechanism for node 1000. Multiple antennas and/or arrays of antennas may be utilized. Additionally, examples of node 1000 may communicate using wired techniques rather than (or in addition to) wireless techniques. For example, in FIG. 11 access node 1104 may communicate wirelessly to user equipment 1102 and may communicate by a wired connection (for example, by optical or coaxial cable) to core network element 1106. Other communication hardware, such as a network interface card (NIC), may be included as well.

As shown in FIG. 10, node 1000 may include processor 1002. Although only one processor is shown, it is understood that multiple processors can be included. Processor 1002 may include microprocessors, microcontrollers, digital signal processors (DSPs), application-specific integrated circuits (ASICs), field-programmable gate arrays (FPGAs), programmable logic devices (PLDs), state machines, gated logic, discrete hardware circuits, and other suitable hardware configured to perform the various functions described throughout the present disclosure. Processor 1002 may be a hardware device having one or many processing cores. Processor 1002 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. Software can include computer instructions written in an interpreted language, a compiled language, or machine code. Other techniques for instructing hardware are also permitted under the broad category of software. Processor 1002 may be a baseband chip. Node 1000 may also include other processors, not shown, such as a central processing unit of the device, a graphics processor, or the like. Processor 1002 may include internal memory (also known as local memory, not shown in FIG. 10) that may serve as memory for L2 data. Processor 1002 may include a radio frequency chip, for example, integrated into a baseband chip, or a radio frequency chip may be provided separately. Processor 1002 may be configured to operate as a modem of node 1000, or may be one element or component of a modem. Other arrangements and configurations are also permitted.

As shown in FIG. 10, node 1000 may also include memory 1004. Although only one memory is shown, it is understood that multiple memories can be included. Memory 1004 can broadly include both memory and storage. For example, memory 1004 may include random-access memory (RAM), read-only memory (ROM), static RAM (SRAM, dynamic RAM (DRAM), ferro-electric RAM (FRAM), electrically erasable programmable ROM (EEPROM), CD-ROM or other optical disk storage, hard disk drive (HDD), such as magnetic disk storage or other magnetic storage devices, Flash drive, solid-state drive (SSD), or any other medium that can be used to carry or store desired program code in the form of instructions that can be accessed and executed by processor 1002. Broadly, memory 1004 may be embodied by any computer-readable medium, such as a non-transitory computer-readable medium. The memory 1004 may be shared by processor 1002 and other components of node 1000, such as the unillustrated graphic processor or central processing unit.

As shown in FIG. 11, wireless network 1100 may include a network of nodes, such as a UE 1102, an access node 1104, and a core network element 1106. User equipment 1102 may be any terminal device, such as a mobile phone, a desktop computer, a laptop computer, a tablet, a vehicle computer, a gaming console, a printer, a positioning device, a wearable electronic device, a smart sensor, or any other device capable of receiving, processing, and transmitting information, such as any member of a vehicle to everything (V2X) network, a cluster network, a smart grid node, or an Internet-of-Things (IoT) node. It is understood that user equipment 1102 is illustrated as a mobile phone simply by way of illustration and not by way of limitation.

Access node 1104 may be a device that communicates with user equipment 1102, such as a wireless access point, a base station (BS), a Node B, an enhanced Node B (eNodeB or eNB), a next-generation NodeB (gNodeB or gNB), a cluster master node, or the like. Access node 1104 may have a wired connection to user equipment 1102, a wireless connection to user equipment 1102, or any combination thereof. Access node 1104 may be connected to user equipment 1102 by multiple connections, and user equipment 1102 may be connected to other access nodes in addition to access node 1104. Access node 1104 may also be connected to other UEs. It is understood that access node 1104 is illustrated by a radio tower by way of illustration and not by way of limitation.

Core network element 1106 may serve access node 1104 and user equipment 1102 to provide core network services. Examples of core network element 1106 may include a home subscriber server (HSS), a mobility management entity (MME), a serving gateway (SGW), or a packet data network gateway (PGW). These are examples of core network elements of an evolved packet core (EPC) system, which is a core network for the LTE system. Other core network elements may be used in LTE and in other communication systems. In some embodiments, core network element 1106 includes an access and mobility management function (AMF) device, a session management function (SMF) device, or a user plane function (UPF) device, of a core network for the NR system. It is understood that core network element 1106 is shown as a set of rack-mounted servers by way of illustration and not by way of limitation.

Core network element 1106 may connect with a large network, such as the Internet 1108, or another IP network, to communicate packet data over any distance. In this way, data from user equipment 1102 may be communicated to other UEs connected to other access points, including, for example, a computer 1110 connected to Internet 1108, for example, using a wired connection or a wireless connection, or to a tablet 1112 wirelessly connected to Internet 1108 via a router 1114. Thus, computer 1110 and tablet 1112 provide additional examples of possible UEs, and router 1114 provides an example of another possible access node.

A generic example of a rack-mounted server is provided as an illustration of core network element 1106. However, there may be multiple elements in the core network including database servers, such as a database 1116, and security and authentication servers, such as an authentication server 1118. Database 1116 may, for example, manage data related to user subscription to network services. A home location register (HLR) is an example of a standardized database of subscriber information for a cellular network. Likewise, authentication server 1118 may handle authentication of users, sessions, and so on. In the NR system, an authentication server function (AUSF) device may be the specific entity to perform user equipment authentication. In some embodiments, a single server rack may handle multiple such functions, such that the connections between core network element 1106, authentication server 1118, and database 1116, may be local connections within a single rack.

Each of the elements of FIG. 11 may be considered a node of wireless network 1100. More detail regarding the possible implementation of a node is provided by way of example in the description of a node 1000 in FIG. 10 above. Node 1000 may be configured as user equipment 1102, access node 1104, or core network element 1106 in FIG. 11. Similarly, node 1000 may also be configured as computer 1110, router 1114, tablet 1112, database 1116, or authentication server 1118 in FIG. 11.

In various aspects of the present disclosure, the functions described herein may be implemented in hardware, software, firmware, or any combination thereof. If implemented in software, the functions may be stored on or encoded as instructions or code on a non-transitory computer-readable medium. Computer-readable media includes computer storage media. Storage media may be any available media that can be accessed by a computing device, such as node 1000 in FIG. 10. By way of example, and not limitation, such computer-readable media can include RAM, ROM, EEPROM, CD-ROM or other optical disk storage, HDD, such as magnetic disk storage or other magnetic storage devices, Flash drive, SSD, or any other medium that can be used to carry or store desired program code in the form of instructions or data structures and that can be accessed by a processing system, such as a mobile device or a computer. Disk and disc, as used herein, includes CD, laser disc, optical disc, DVD, and floppy disk where disks usually reproduce data magnetically, while discs reproduce data optically with lasers. Combinations of the above should also be included within the scope of computer-readable media.

According to one aspect, a method for fallback handling can include operating a user equipment in a fifth-generation (5G) radio access technology. The method can also include maintaining second-generation (2G) and third-generation (3G) physical layer components in a warm state. The method can additionally include maintaining 2G and 3G layer 2 components in an inactive state.

In some embodiments, the method can further include powering up at least one of the 2G and 3G layer 2 components when it is determined that fallback should occur.

In some embodiments, the method can further include reselecting from the 5G radio access technology to a fourth-generation (4G) radio access technology. The maintaining the 2G and 3G physical layer components in the warm state and maintaining the 2G and 3G layer 2 components in the inactive state can continue after the reselecting to the 4G radio access technology.

In some embodiments, the user equipment can be configured to operate in at least one standalone mode or non-standalone mode in the 5G radio access technology.

In some embodiments, the method can further include maintaining fourth-generation (4G) physical layer components in a warm state. The method can additionally include maintaining 4G layer 2 components in an inactive state.

According to another aspect, a method for fallback handling can include operating a user equipment in a fifth-generation (5G) radio access technology. The method can also include transitioning to a second-generation (2G) or third-generation (3G) radio access technology only when out of service (OOS) coverage or internet protocol (IP) multimedia subsystem (IMS) failure occur.

In some embodiments, the method can further include detecting that the user equipment is experience OOS coverage of 5G. The transitioning can be based on the detected OOS coverage.

In some embodiments, the method can also include detecting an IMS failure. The transitioning can be based on the detected IMS failure.

In some embodiments, the user equipment can be configured to operate in at least one standalone mode or non-standalone mode in the 5G radio access technology.

According to a further aspect, a method for fallback handling can include operating a user equipment in a fifth-generation (5G) radio access technology. The method can also include determining a likelihood of fallback to at least one of a second-generation (2G) or third-generation (3G) radio access technology. The method can further include falling back to the 2G or 3G radio access technology only when the likelihood exceeds a threshold.

In some embodiments, the determining can include taking into account a location of a neighboring legacy base station

In some embodiments, the determining can include taking into account signal characteristics of signals received at the user equipment.

In some embodiments, the determining can include taking into account average data buffer queue size at the user equipment.

In some embodiments, the determining can include taking into account a smallest latency value of a packet data application at the user equipment.

In some embodiments, the determining can be performed contingent upon a determination that received power has fallen below a threshold power level for a predetermined time period.

According to yet another aspect, a method for fallback handling can include operating a user equipment in a fifth-generation (5G) radio access technology. The method can also include falling back to at least one of a second-generation (2G), third-generation (3G), or fourth-generation (4G) radio access technology. The method can further include, when attempting to return to the 5G radio access technology from the 2G, 3G, or 4G radio access technology, performing only idle mode search of the 5G radio access technology system.

According to a further aspect, an apparatus for fallback handling can include at least one processor and at least one memory including computer program code. The at least one memory and the computer program code can be configured to, with the at least one processor, cause the apparatus at least to operate the apparatus in a fifth-generation (5G) radio access technology. The at least one memory and the computer program code can also be configured to, with the at least one processor, cause the apparatus at least to maintain second-generation (2G) and third-generation (3G) physical layer components in a warm state. The at least one memory and the computer program code can further be configured to, with the at least one processor, cause the apparatus at least to maintain 2G and 3G layer 2 components in an inactive state.

According to another aspect, an apparatus for fallback handling can include at least one processor and at least one memory including computer program code. The at least one memory and the computer program code can be configured to, with the at least one processor, cause the apparatus at least to operate the apparatus in a fifth-generation (5G) radio access technology. The at least one memory and the computer program code can also be configured to, with the at least one processor, cause the apparatus at least to transition to a second-generation (2G) or third-generation (3G) radio access technology only when out of service (OOS) coverage or internet protocol (IP) multimedia subsystem (IMS) failure occur.

According to an additional aspect, an apparatus for fallback handling can include at least one processor and at least one memory including computer program code. The at least one memory and the computer program code can be configured to, with the at least one processor, cause the apparatus at least to operate the apparatus in a fifth-generation (5G) radio access technology. The at least one memory and the computer program code can also be configured to, with the at least one processor, cause the apparatus at least to determine a likelihood of fallback to at least one of a second-generation (2G) or third-generation (3G) radio access technology. The at least one memory and the computer program code can further be configured to, with the at least one processor, cause the apparatus at least to fall back to the 2G or 3G radio access technology only when the likelihood exceeds a threshold.

According to a yet further aspect, an apparatus for fallback handling can include at least one processor and at least one memory including computer program code. The at least one memory and the computer program code can be configured to, with the at least one processor, cause the apparatus at least to operate the apparatus in a fifth-generation (5G) radio access technology. The at least one memory and the computer program code can also be configured to, with the at least one processor, cause the apparatus at least to fall back to at least one of a second-generation (2G), third-generation (3G), or fourth-generation (4G) radio access technology. The at least one memory and the computer program code can further be configured to, with the at least one processor, cause the apparatus at least to, when attempting to return to the 5G radio access technology from the 2G, 3G, or 4G radio access technology, perform only idle mode search of the 5G radio access technology system.

The foregoing description of the specific embodiments will so reveal the general nature of the present disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The Summary and Abstract sections may set forth one or more but not all exemplary embodiments of the present disclosure as contemplated by the inventor(s), and thus, are not intended to limit the present disclosure and the appended claims in any way.

Various functional blocks, modules, and steps are disclosed above. The particular arrangements provided are illustrative and without limitation. Accordingly, the functional blocks, modules, and steps may be re-ordered or combined in different ways than in the examples provided above. Likewise, certain embodiments include only a subset of the functional blocks, modules, and steps, and any such subset is permitted.

The breadth and scope of the present disclosure should not be limited by any of the above-described exemplary embodiments, but should be defined only in accordance with the following claims and their equivalents.

What is claimed is:

1. A method for fallback handling, comprising:
operating a user equipment in a fifth-generation (5G) radio access technology;
maintaining second-generation (2G) and third-generation (3G) physical layer components in a warm state; and
maintaining 2G and 3G layer 2 components in an inactive state.

2. The method of claim 1, further comprising:
powering up at least one of the 2G and 3G layer 2 components when it is determined that fallback should occur.

3. The method of claim 1, further comprising:
reselecting from the 5G radio access technology to a fourth-generation (4G) radio access technology, wherein the maintaining the 2G and 3G physical layer components in the warm state and maintaining the 2G and 3G layer 2 components in the inactive state continues after the reselecting to the 4G radio access technology.

4. The method of claim 1, wherein the user equipment is configured to operate in at least one standalone mode or non-standalone mode in the 5G radio access technology.

5. The method of claim 1, further comprising:
maintaining fourth-generation (4G) physical layer components in a warm state; and
maintaining 4G layer 2 components in an inactive state.

6. An apparatus for fallback handling, comprising:
at least one processor; and
at least one memory including computer program code,
wherein the at least one memory and the computer program code are configured to, with the at least one processor, cause the apparatus to perform:
operating a user equipment in a fifth-generation (5G) radio access technology; and
transitioning to a second-generation (2G) or third-generation (3G) radio access technology only when out of service (OOS) coverage or internet protocol (IP) multimedia subsystem (IMS) failure occurs.

7. The apparatus of claim 6, wherein the at least one memory and the computer program code are further configured to, with the at least one processor, cause the apparatus to perform:
detecting that the user equipment is experiencing an OOS coverage of 5G,
wherein the transitioning is based on the OOS coverage.

8. The apparatus of claim 6, wherein the at least one memory and the computer program code are further configured to, with the at least one processor, cause the apparatus to perform:
detecting an IMS failure,
wherein the transitioning is based on the detected IMS failure.

9. The apparatus of claim 6, wherein the user equipment is configured to operate in at least one standalone mode or non-standalone mode in the 5G radio access technology.

10. A method for fallback handling, comprising:
operating a user equipment in a fifth-generation (5G) radio access technology; and
at least one of:
determining a likelihood of fallback to at least one of a second-generation (2G) or third-generation (3G) radio access technology, and falling back to the 2G or 3G radio access technology only when the likelihood exceeds a threshold; or
falling back to at least one of a 2G, 3G, or fourth-generation (4G) radio access technology, and when attempting to return to the 5G radio access technology from the 2G, 3G, or 4G radio access technology, performing only idle mode search of the 5G radio access technology system.

11. The method of claim 10, wherein the determining comprises taking into account a location of a neighboring legacy base station.

12. The method of claim 10, wherein the determining comprises taking into account signal characteristics of signals received at the user equipment.

13. The method of claim 10, wherein the determining comprises taking into account average data buffer queue size at the user equipment.

14. The method of claim 10, wherein the determining comprises taking into account a smallest latency value of a packet data application at the user equipment.

15. The method of claim 10, wherein the determining is performed contingent upon a determination that received power has fallen below a threshold power level for a predetermined time period.

16. An apparatus for fallback handling, comprising:
at least one processor; and
at least one memory including computer program code,
wherein the at least one memory and the computer program code are configured to, with the at least one processor, cause the apparatus to perform:
operating the apparatus in a fifth-generation (5G) radio access technology;
maintaining second-generation (2G) and third-generation (3G) physical layer components in a warm state; and
maintaining 2G and 3G layer 2 components in an inactive state.

17. The apparatus of claim 16, wherein the at least one memory and the computer program code are further configured to, with the at least one processor, cause the apparatus to perform:
powering up at least one of the 2G and 3G layer 2 components when it is determined that fallback should occur.

18. The apparatus of claim 16, wherein the at least one memory and the computer program code are further configured to, with the at least one processor, cause the apparatus to perform:
reselecting from the 5G radio access technology to a fourth-generation (4G) radio access technology, wherein the maintaining the 2G and 3G physical layer components in the warm state and maintaining the 2G and 3G layer 2 components in the inactive state continues after the reselecting to the 4G radio access technology.

19. The apparatus of claim 16, wherein the apparatus is configured to operate in at least one standalone mode or non-standalone mode in the 5G radio access technology.

20. The apparatus of claim 16, wherein the at least one memory and the computer program code are further configured to, with the at least one processor, cause the apparatus to perform:
maintaining fourth-generation (4G) physical layer components in a warm state; and
maintaining 4G layer 2 components in an inactive state.
